(19) United States
(12) Patent Application Publication
(10) Pub. No.: US 2008/0259988 A1
(43) Pub. Date: Oct. 23, 2008

(54) OPTICAL ACTUATOR WITH IMPROVED RESPONSE TIME AND METHOD OF MAKING THE SAME

(75) Inventors: Yuri Grapov, Sutton, MA (US); Dennis Elkins, Draper, UT (US); David Owen, West Jordan, UT (US); Tatyana Chernysheva, Salt Lake City, UT (US)

Correspondence Address: GRANT R CLAYTON;CLAYTON HOWARTH & CANNON, PC, P O BOX 1909, SANDY, UT, 84091-1909, US

(73) Assignee: EVANS & SUTHERLAND COMPUTER CORPORATION, Salt Lake City, UT (US)

(21) Appl. No.: 12/018,024

(22) Filed: Jan. 22, 2008

Related U.S. Application Data
(60) Provisional application No. 60/881,277, filed on Jan. 19, 2007.

(51) Int. Cl. H01S 3/00; B05D 5/06

(52) U.S. Cl. 372/98; 427/162

(57) ABSTRACT

An optical actuator having an improved response time and an improved frequency operational range due to the reduced mass of a substrate coupled to an actuator and method of making the same. The optical actuator may be formed by adhering an uncoated substrate to the actuator using an epoxy. Once cured, any deformities and irregularities in a top surface of the substrate are removed. An optical coating is then applied to the top surface of the substrate. Once finished, the optical actuator may be used in a laser resonating cavity. Further, the optical actuator desirably may have a resonant frequency of about 150 kHz.

### CROSS-REFERENCE TO RELATED APPLICATIONS

This application claims the benefit of U.S. Provisional Application No. 60/881,277 filed on Jan. 19, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Technical Field

The present disclosure relates generally to optical actuators, and more particularly, but not necessarily entirely, to optical actuators with improved response times.

2. Description of Background Art

An optical actuator may include a substrate attached to a piezoelectric actuator. Piezoelectric actuators are devices which can produce accurately small displacements with a high force capability when a voltage is applied. There are many applications where a piezoelectric actuator may be used, such as ultra-precise positioning and in the generation and handling of high forces or pressures in static or in dynamic situations. Piezoelectric actuators also have applications in the operation of resonance cavities for lasers.

Actuator configuration can vary greatly depending on the application. Piezoelectric stack actuators are manufactured by stacking up piezoelectric disks or plates, the axis of the stack being the axis of linear motion when a voltage is applied. Tube actuators are monolithic devices that contract laterally and longitudinally when a voltage is applied between the inner and outer electrodes. A disk actuator is a device in the shape of a planar disk. Ring actuators are disk actuators with a center bore, making the actuator axis accessible for optical, mechanical, or electrical purposes. Other less common configurations include block, disk, bender, and bimorph styles.

The critical specifications for piezoelectric actuators are the displacement, force and operating voltage of the actuator. Other factors to consider are stiffness, resonant frequency and capacitance. Stiffness is a term used to describe the force needed to achieve a certain deformation of a structure. For piezoelectric actuators, it is the force needed to elongate the device by certain amount. It is normally specified in terms of Newton per micrometer. Resonance is the frequency at which the actuators respond with maximum output amplitude. The capacitance is a function of the excitation voltage frequency.

Piezoelectric actuators may be used in frequency stabilization of laser light systems. One frequency stabilization scheme is the Pound-Drever (PD) method. For more information see Drever et al., Appl. Phys. B 31, 97-105 (1983), which is incorporated herein by reference in its entirety. This method uses a phase discriminant to control the cavity lock of the resonator. Most often, the PD method is used to move a mirror within the external cavity using piezoelectric control to adjust the cavity length. Other applications of the PD method have adjusted the laser source frequency using piezoelectric control. Another example of using a piezoelectric actuator for use with a laser system is found in U.S. Pat. No. 6,763,042, which is hereby incorporated by reference in its entirety.

Where an optical component is attached to a piezoelectric actuator, the response time of a piezoelectric actuator is governed by the inherent specifications of the actuator, discussed above, as well as by the mass of the substrate attached to the actuator. Pursuant to Newton's Second Law of Motion, the relationship between the optical component's mass m, its acceleration a, and the applied force F is F=ma. Thus, applying this law to improving the response or switching time of an optical piezoelectric actuator means that the smaller the mass of the substrate (the mass of the reflective surface being insubstantial) attached to the actuator, the faster the acceleration given a fixed amount of force. This concept becomes very useful when the goal of the switching optics is to help with phase matching in an enhancement cavity.

Reducing the mass of a substrate, however, can lead to serious problems. Every material has certain physical thresholds such as the amount of stresses and strains they can resist before they deform. Often substrates, based upon the material they are made out of, will have a particular thickness so as to maintain a specific flatness when in use. This characteristic is particularly true of coated optics. Problems have arisen when attaching an optical piece such as a mirror to an actuator. If the thickness of the mirror is too thin, the mirror may deform during the attachment process. In particular, when the mirror is attached to the actuator, the epoxy adhesive used to attach the mirror may cause a deformation in the mirror's reflective surface as the epoxy cures. Thus, in order to maintain the integrity of the mirror and to not induce too great of stresses that would distort the mirror's surface, the previously available methods did not allow the mirror's thickness to be reduced below a certain threshold. This “thickness” requirement has prevented the mirror's mass from being reduced below the previously thought threshold to improve the response time of the actuator.

The prior art is thus characterized by several disadvantages that are addressed by the present disclosure. The present disclosure minimizes, and in some aspects eliminates, the above-mentioned failures, and other problems, by utilizing the methods and structural features described herein. The features and advantages of the disclosure will be set forth in the description which follows, and in part will be apparent from this description, or may be learned by the practice of the disclosure without undue experimentation. The features and advantages of this disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1A is a top view of an optical substrate;

FIG. 1B is a perspective view of the substrate illustrated in FIG. 1A;

FIG. 2 is an exploded view of an optical actuator assembly;

FIG. 3 is a perspective view of a partially completed optical actuator;

FIG. 4 is an unexploded view of an optical actuator; and

FIG. 5 is a perspective view of an optical actuator mounted in a spherical mount assembly for use in a laser cavity.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

As used herein, the terms “comprising,” “including,” “containing,” “characterized by,” and grammatical equivalents thereof are inclusive or open-ended terms that do not exclude additional, unrecited elements or method steps.

Applicant has discovered a method and structure for reducing the mass of a substrate attached to an actuator, such as a piezoelectric actuator. The reduced mass of the substrate results in improved actuator response time. The present disclosure is able to reduce the thickness of the substrate to a size that was previously thought unattainable, while maintaining the integrity of, and avoid deformity in, the substrate. The benefits of the improved response time include a faster response, faster oscillations, less power consumption and increased efficiency. The increased response time of the present disclosure is very well suited for use in conjunction with a non-linear enhancement cavity system, such as the one described in U.S. Pat. No. 6,763,042, which is incorporated herein by reference in its entirety.

Thus, the advantages of the present disclosure are that the substrate's mass is extensively reduced enabling a completed optical actuator unit to operate faster. This may also reduce the energy or force required to move the substrate. In addition, the overall packaging size of the completed optical actuator is reduced as well. Moreover, the faster response time allows for less susceptibility to interference from outside sources, including thermal variations, audio interference, vibrations, and jolts when used in a laser cavity. Thus, systems employing the applicants' optical actuators enjoy a greater robustness and reliability when compared to the previously available systems.

Prior to the advent of the present disclosure, the general rule for optical actuators was that the length of the effective aperture of a substrate, e.g., a diameter of a circle or a diagonal of a square, should not be greater than four times the thickness of the substrate. In particular, it was well recognized that a substrate having too thin of a thickness when compared to its effective aperture had the tendency to warp or deform when bonded to an actuator due to forces imposed by the curing of the bonding adhesive. Thus, prior to the present disclosure, the thicknesses of substrates used in optical actuators were maintained relatively large when compared to their effective apertures. These relatively large thicknesses, however, disadvantageously resulted high mass which were required to be accelerated and in low response times.

Further, prior to the present disclosure, the method of forming an optical actuator involved cutting a substrate, polishing the substrate, applying an optical coating to the substrate, and then adhering the substrate to the actuator. This procedure required the use of a substrate that was relatively thick compared to its effective aperture. The present disclosure is able reduce the thickness of the substrate used in an optical actuator by approximately half, or more, of what was previously possible and in spite of scepticism by others having ordinary skill in the art.

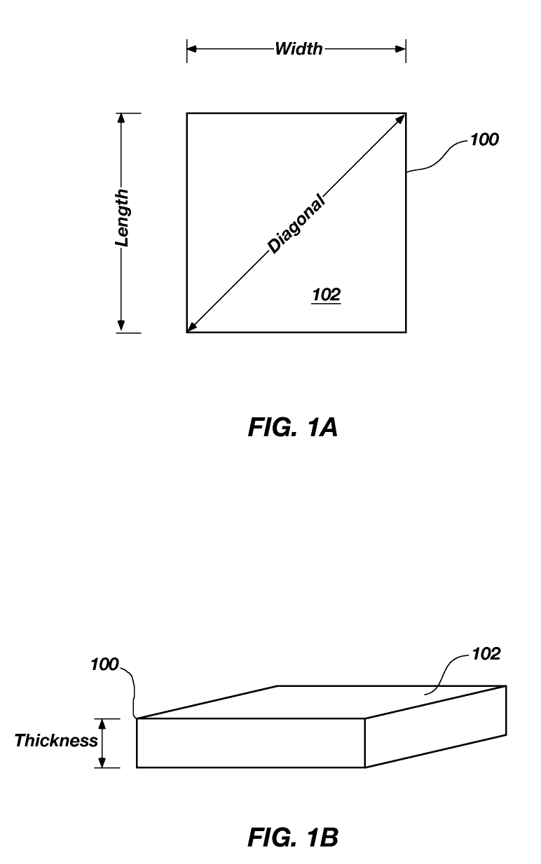

Referring now to FIGS. 1A and 1B, there is shown a substrate 100. The substrate 100 has a top surface 102 that has a substantially rectangular shape. It will be noted that the top surface 102 may be other shapes, including substantially circular. The substrate 100 comprises a length, a width, and a thickness as shown by the double arrows in FIGS. 1A and 1B. The substrate 100 may be glass, including fused silica, or any other suitable substrate material. The substrate 100 may be cut from a larger piece of material. In one illustrative embodiment, the dimensions of the substrate 100 are 3×3×0.5 millimeters (length, width, thickness). The length of the diagonal of the substrate 100 indicated in FIG. 1A illustrates the effective aperture for the substrate 100. Thus, the effective aperture of a substrate having the dimensions given above, 3×3×0.5 millimeters, is approximately 4.24 millimeters. In this embodiment, the ratio of the length of the effective aperture to the thickness is therefore approximately 8.5, more than double the previously allowed ratio of four (4). That is, the length of the effective aperture is more than eight (8) times the thickness of the substrate 100. In one illustrative embodiment, the substrate 100 is Corning 7980 OC glass. In the illustrative embodiment, the thickness of the substrate 100 is less than 0.5 millimeters. It will be appreciated that the drawings referred to herein are not to scale and those skilled in the art will understand what precise dimensions are appropriate for each circumstance.

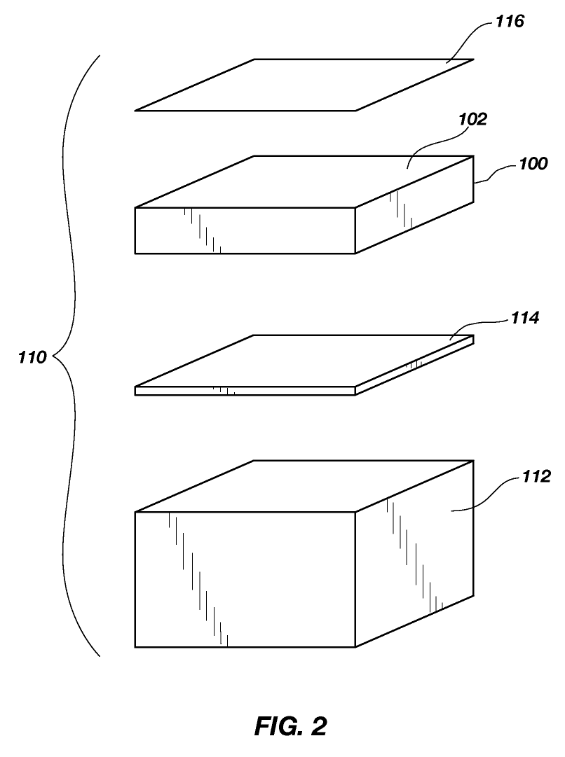

Referring now to FIG. 2, there is shown an exploded perspective view of an optical actuator assembly 110. The assembly 110 comprises an actuator 112, such as a piezoelectric actuator, a layer of adhesive 114, the substrate 100, and an optical coating 116. The adhesive 114 is used to bond the substrate 100 to the actuator 112. The optical coating 116 is applied to a top surface 102 of the substrate 100. The optical coating 116 may be designed for wavelength specific applications. That is, the optical coating 116 may be highly reflective for a specified wavelength.

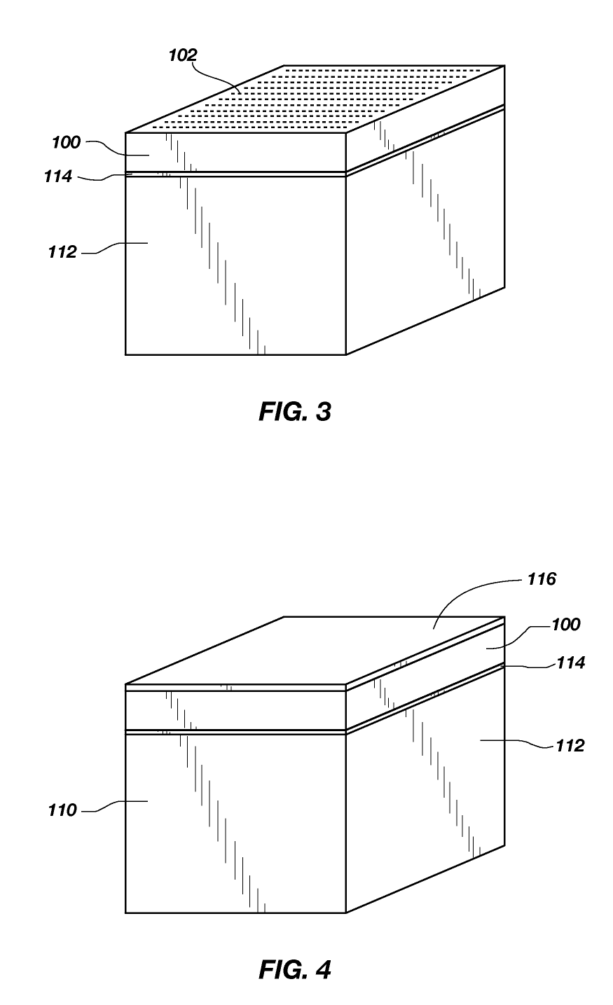

A illustrative process of making the optical actuator assembly 110 will now be described. The uncoated substrate 100 is bonded to a surface of the actuator 112 using the adhesive 114. In one illustrative embodiment, the adhesive 114 is a long pot life room temperature curing epoxy. A suitable adhesive for use with the present disclosure is TRA-BOND 224-1 epoxy manufactured by Tra-Con, Inc. To ensure that no bubbles are present in the adhesive 114 while curing, a vacuum chamber may be utilized. As the adhesive 114 cures, deformations and other irregularities may form in the top surface 102 of the substrate 100. These deformations and irregularities are represented by the dashed lines shown on the top surface 102 of the substrate 100 in FIG. 3.

Once the adhesive 114 has cured, the top surface 102 of the substrate 100 is subjected to a process to remove the deformations and irregularities shown in FIG. 3 and depicted by the dashed lines on the top surface 102. This process may include at least one of grinding, lapping and polishing. Lapping involves a process in which two surfaces are rubbed together with an abrasive between them. Polishing involves a process in which the surface 102 is super polished.

Once the deformations and irregularities in the top surface 102 have been removed, the top surface 102 is then coated with the appropriate optical coating 116 using a multilayer deposition process. A completed optical actuator 110 is illustrated in FIG. 4 where the same reference numerals depict similar components.

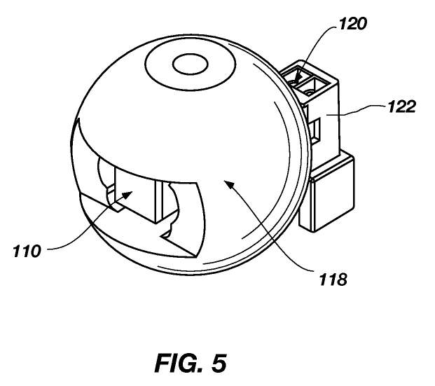

The completed optical actuator 110 may be mounted in a spherical mounting assembly 118 as shown in FIG. 5. The spherical mounting assembly 118 may include electrical connections 120 for controlling the actuator as well as a bracket 122. Using the present disclosure, the length of the effective aperture of an optical component may desirably be greater than four, five, six, seven, eight or even more than eight times the thickness of the underlying substrate.

It will be appreciated that a benefit of the present disclosure is an increased operational frequency range of the optical actuator 110. In particular, the inherent resonant frequency of an optical actuator is often the limiting factor in a control loop for a laser cavity as an optical actuator operating at or near its resonant frequency tends to become unstable and, therefore, is unable to maintain resonance in the laser cavity. That is, if an optical actuator oscillates between positions at or near its inherent resonant frequency, the optical actuator may become uncontrollable due to the large amplitudes of motion that occur at this frequency. However, it is often desirable to oscillate optical actuators as close as possible to their resonant frequencies, without causing the system to become unstable, as the higher the operational frequency range of an optical actuator, the greater is its ability to compensate for any interference. In the past, the operational frequency range of optical actuators typically could not exceed about 20 kHz. This relatively low limit on the operational frequency range of the previously available optical actuators is largely due to the relatively large mass of the substrates bonded to the actuators.

The optical actuator 110, on the other hand, is able to continuously and rapidly oscillate to compensate for almost any interference due to its relatively high operational frequency when compared to previously available optical actuators. In fact, the optical actuator 110 may have a resonant frequency of about 150 kHz. Thus, the optical actuator 110 may oscillate near 150 kHz. The increased operational frequency range of the optical actuator 110 is believed to be due to the decreased mass of the substrate 100 bonded to the actuator 112.

An illustrative embodiment of the present disclosure includes a laser apparatus having a laser cavity, such as a cavity with a bow tie configuration, with an optical path. Positioned in the optical path is an optical actuator for adjusting the length of the optical path inside of the laser cavity. The optical actuator may have a resonant frequency exceeding at least one of 30 kHz, 45 kHz, 80 kHz, 115 kHz, and 140 kHz. Further, in an illustrative embodiment of the present disclosure, the optical actuator may have a resonant frequency of about 150 kHz. It will therefore be appreciated that an optical actuator pursuant to the present disclosure is able to be operated at a significantly higher operational frequency than the previously available optical actuators.

Those having ordinary skill in the relevant art will appreciate the advantages provided by the features of the present disclosure. For example, it is a feature of the present disclosure to provide an optical actuator with an improved response time and increased acceleration. Moreover, while the present disclosure is described for use with piezoelectric optical actuator, it will be appreciated by those skilled in the pertinent art that other types of actuators may also benefit therefrom.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of making an optical actuator, said method comprising the steps of:
adhering a substrate to an actuator using an adhesive material, the substrate having a surface;
removing deformities from the surface of the substrate after the adhesive material has cured; and
applying an optical coating to the surface of the substrate after the deformities in the surface have been removed.

2. The method of claim 1, further comprising the step of grinding the surface of the substrate after the adhesive material has cured.

3. The method of claim 1, wherein a length of an effective aperture of the substrate is greater than four times a thickness of the substrate.

4. The method of claim 1, wherein a length of an effective aperture of the substrate is greater than five times a thickness of the substrate.

5. The method of claim 1, wherein a length of an effective aperture of the substrate is greater than six times a thickness of the substrate.

6. The method of claim 1, wherein a length of an effective aperture of the substrate is greater than seven times a thickness of the substrate.

7. The method of claim 1, wherein a length of an effective aperture of the substrate is greater than eight times a thickness of the substrate.

8. The method of claim 1, wherein a thickness of the substrate is approximately 0.5 millimeters.

9. The method of claim 1, wherein a length, a width, and a thickness of the substrate are approximately 3 millimeters, 3 millimeters, and 0.5 millimeters, respectively.

10. The method of claim 1, further comprising the step of placing the actuator and the substrate into a spherical mount.

11. The method of claim 1, wherein the surface of the substrate is substantially rectangular.

12. The method of claim 1, wherein the surface of the substrate is substantially circular.

13. The method of claim 1, wherein the actuator is a piezoelectric actuator.

14. The method of claim 1, further comprising the step of using the substrate and actuator to form part of a light resonating cavity.

15. The method of claim 1, wherein the substrate is glass.

16. A method of making an optical actuator, said method comprising the steps of:
adhering a substrate to an actuator using an adhesive material, the substrate having a surface;
removing any deformities from the surface of the substrate; and
applying an optical coating to the surface of the substrate for wavelength specific applications.

17. The method of claim 16, further comprising the step of grinding or polishing the surface of the substrate after the adhesive material has cured.

18. The method of claim 16, wherein a length of an effective aperture of the substrate is greater than four times a thickness of the substrate.

19. The method of claim 16, wherein a length of an effective aperture of the substrate is greater than five times a thickness of the substrate.

20. The method of claim 16, wherein a length of an effective aperture of the substrate is greater than six times a thickness of the substrate.

21. The method of claim 16, wherein a length of an effective aperture of the substrate is greater than seven times a thickness of the substrate.

22. The method of claim 16, wherein a length of an effective aperture of the substrate is greater than eight times a thickness of the substrate.

23. The method of claim 16, wherein a thickness of the substrate is approximately 0.5 millimeters.

24. The method of claim 16, wherein a length, a width, and a thickness of the substrate are approximately 3 millimeters, 3 millimeters, and 0.5 millimeters, respectively.

25. The method of claim 16, further comprising the step of placing the actuator and the substrate into a spherical mount.

26. The method of claim 16, wherein the surface of the substrate is substantially rectangular.

27. The method of claim 16, wherein the surface of the substrate is substantially circular.

28. The method of claim 16, wherein the actuator is a piezoelectric actuator.

29. The method of claim 16, further comprising the step of using the substrate and the actuator to form part of a light resonating cavity.

30. The method of claim 16, wherein the substrate is glass.

31. The method of claim 16, further comprising the step of lapping the surface of the substrate after the adhesive material has cured.

32. The method of claim 16, further comprising the step of super polishing the surface.

33. The method of claim 16, wherein a thickness of the substrate is less than 0.5 millimeters.

34. An optical actuator for use in a light resonating cavity, said optical actuator comprising:
an actuator;
a substrate bonded to the actuator, the substrate having a surface, an effective aperture, and a thickness;
an optical coating disposed on the surface of the substrate; and
wherein the size of the effective aperture of the substrate is greater than four times the thickness of the substrate.

35. The optical actuator of claim 34, wherein the size of the effective aperture of the substrate is greater than five times the thickness of the substrate.

36. The optical actuator of claim 34, wherein the size of the effective aperture of the substrate is greater than six times the thickness of the substrate.

37. The optical actuator of claim 34, wherein the size of the effective aperture of the substrate is greater than seven times the thickness of the substrate.

38. The optical actuator of claim 34, wherein the size of the effective aperture of the substrate is greater than eight times the thickness of the substrate.

39. The optical actuator of claim 34, wherein the thickness of the substrate is approximately 0.5 millimeters.

40. The optical actuator of claim 34, wherein the actuator is a piezoelectric actuator.

41. A laser apparatus comprising:
a light resonating cavity having an optical path length; and
an optical actuator for varying the optical path length of the light resonating cavity to thereby maintain resonance in the laser cavity; and
wherein said optical actuator has a resonant frequency exceeding 30 kHz.

42. The laser apparatus of claim 41, wherein said optical actuator has a resonant frequency exceeding 45 kHz.

43. The laser apparatus of claim 41, wherein said optical actuator has a resonant frequency exceeding 80 kHz.

44. The laser apparatus of claim 41, wherein said optical actuator has a resonant frequency exceeding 115 kHz.

45. The laser apparatus of claim 41, wherein said optical actuator has a resonant frequency exceeding 140 kHz.

47. The laser apparatus of claim 41, wherein said optical actuator has a resonant frequency of about 150 kHz.

46. The laser apparatus of claim 41, wherein said optical actuator comprises a piezoelectric actuator.
